(19) United States
(12) Patent Application Publication
(10) Pub. No.: US 2002/0074692 A1
(43) Pub. Date: Jun. 20, 2002

(54) Bathmat and the method for manufacturing the same

(76) Inventor: Ming-Ling Wang, Changhua (TW)

Correspondence Address: RABIN & CHAMPAGNE, PC, 1101 14TH STREET, NW, SUITE 500, WASHINGTON, DC, 20005, US

(21) Appl. No.: 09/739,330

(22) Filed: Dec. 19, 2000

(51) Int. Cl. B29C 59/02

(52) U.S. Cl. 264/293; 264/320

(57) ABSTRACT

A bathmat manufacturing process comprises forming a bathmat body from a flexible material putting the bathmat body on a lower mold having a plurality of recesses thereon, placing a layer of thin film on the bathmat body, the layer of thin film being formed of thermoplastic material with a mixture of temperature sensitive material, the layer of thin film having a predetermined pattern formed thereon, placing an upper mold on the layer of thin film, the upper mold having a plurality of dents on the bottom, pressing the lower mold and the upper mold on the bathmat body and the layer of thin film and applying heat, and tearing off the layer of thin film. The formed bathmat comprises a plurality of slip resistant protrusions on the top, a plurality of projected suction plates on the bottom, a plurality of irregular grooves each formed between the slip resistant protrusions, and a printed pattern. A warning is shown when the temperature of an object in contact with the pattern of the bathmat is higher than a predetermined temperature.

### FIELD OF THE INVENTION

The present invention relates to bathmats and more particularly to a bathmat and the method for manufacturing the same with improved characteristics.

### BACKGROUND OF THE INVENTION

A conventional bathmat A is shown in FIGS. 1A and 1B comprising a plurality of suction plates A1 on the bottom for releasbly securing to the floor of bathroom and a variety of patterns A2 slightly raised above the top for preventing slipping. But this is unsatisfactory for the purpose for which the invention is concerned for the following reasons: a. The printed patterns A2 are slippery on the surface. As such, the anti-skid feature of the bathmat is compromised. b. The printed patterns A2 may fade as time passes. This may detract the external appearance of bathmat. c. There is no provision of sensor arrangement in the bathmat for providing an approximate indication of the temperature of water spilt from the bathtub unintentionally. This is not safe in some cases.

Thus, it is desirable to provide an improved bathmat and the method for manufacturing the same in order to overcome the above drawbacks of prior art.

### SUMMARY OF THE INVENTION

It is an object of the present invention to provide a bathmat manufacturing process comprising forming a bathmat body from a flexible material putting the bathmat body on a lower mold having a plurality of recesses thereon, placing a layer of thin film on the bathmat body, the layer of thin film being formed of thermoplastic material with a mixture of temperature sensitive material, the layer of thin film having a predetermined pattern formed thereon, placing an upper mold on the layer of thin film, the upper mold having a plurality of dents on the bottom, pressing the lower mold and the upper mold on the bathmat body and the layer of thin film and applying heat, and tearing off the layer of thin film. The formed bathmat comprises a plurality of slip resistant protrusions on the top, a plurality of projected suction plates on the bottom, a plurality of irregular grooves each formed between the slip resistant protrusions, and a printed pattern. A warning is shown when the temperature of an object in contact with the pattern of the bathmat is higher than a predetermined temperature.

In one aspect of tie present invention, the height of each slip resistant protrusion is no more than 0.3 mm and each slip resistant protrusion is substantially rounded.

In another aspect of the present invention, the grooves are capable of dissipating heat during said manufacturing process.

The above and other objects, features and advantages of the present invention will become apparent from the following detailed description taken with the accompanying drawings.

### BRIEF DESCRIPTION OF THE DRAWINGS

FIG. 1A is a perspective view of a conventional bathmat showing the top feature thereof;

FIG. 1B is a view similar to FIG. 1A showing the bottom feature of bathmat;

FIG. 2 is an exploded view of a mat cut out from a piece of material for manufacturing a bathmat according to the invention;

FIG. 3 is an exploded view showing a preparation of mat, lower mold, layer of thin film, and upper mold for manufacturing a bathmat according to the invention;

FIG. 4 is a side view schematically illustrating the bathmat manufacturing process according to the invention wherein mat and layer of thin film have not been pressed by lower mold and upper mold;

FIG. 5 is a view similar to FIG. 4 wherein mat and layer of thin film have been pressed by lower mold and upper mold;

FIG. 6 is a perspective view of a finished bathmat according to the invention;

FIG. 7A is an environmental view of the FIG. 6 bathmat near a bathtub;

FIG. 7B is a greatly enlarged view of the FIG. 7A bathmat wherein water has not spilt over the bathmat from bathtub;

FIG. 8A is an environmental view of the FIG. 7A bathmat wherein water has spilt over the bathmat from bathtub; and

FIG. 8B is a greatly enlarged view of the FIG. 8A bathmat wherein a warning is shown after water has spilt on the bathmat.

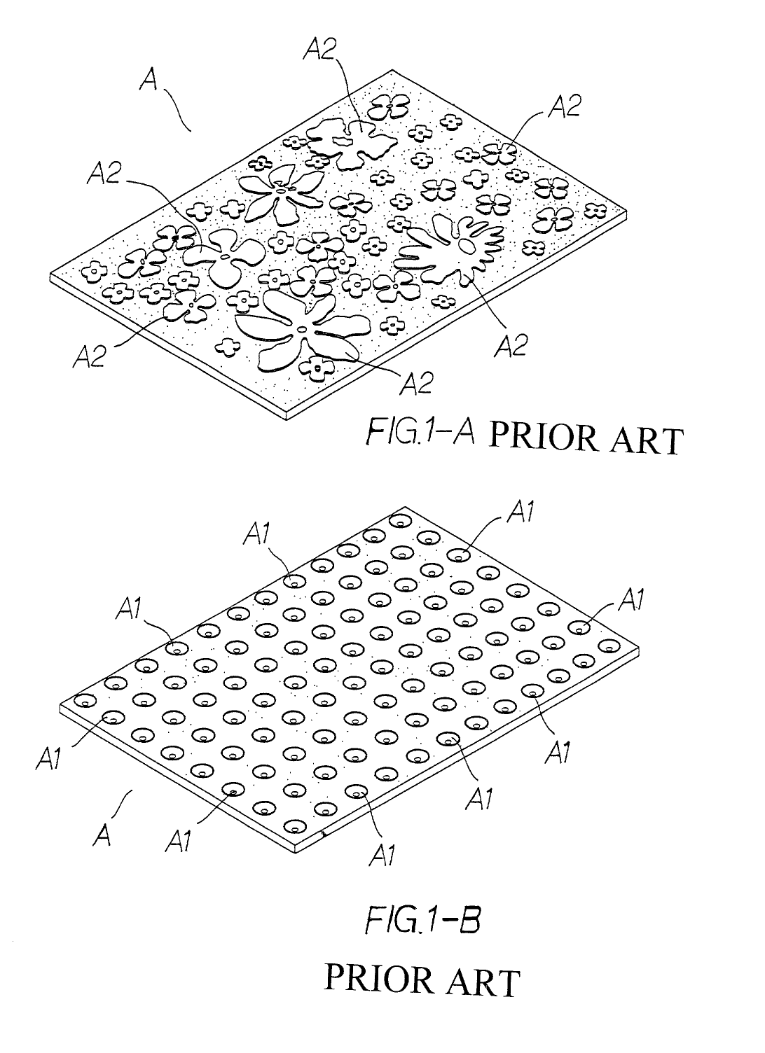

### DETAILED DESCRIPTION OF THE PREFERRED EMBODIMENTS

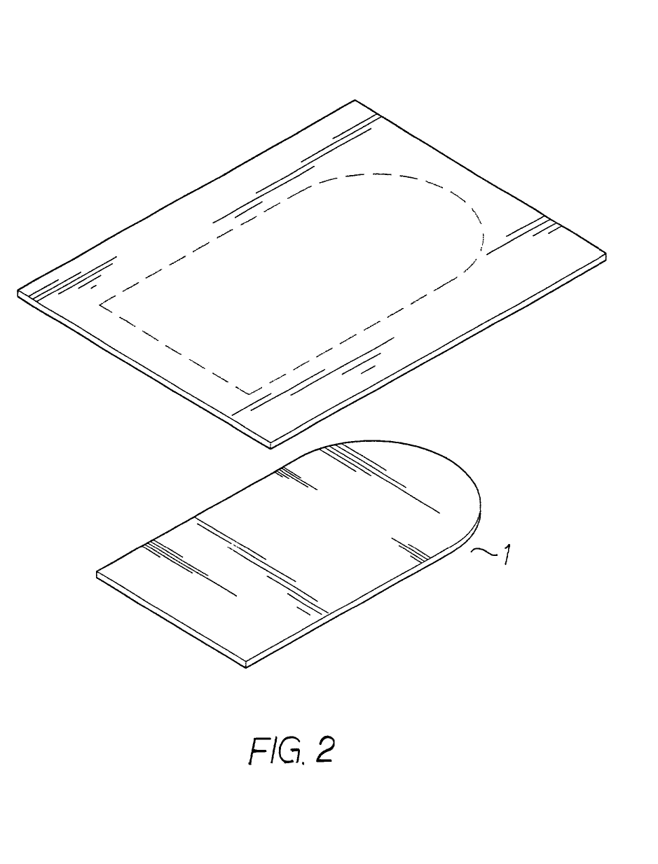

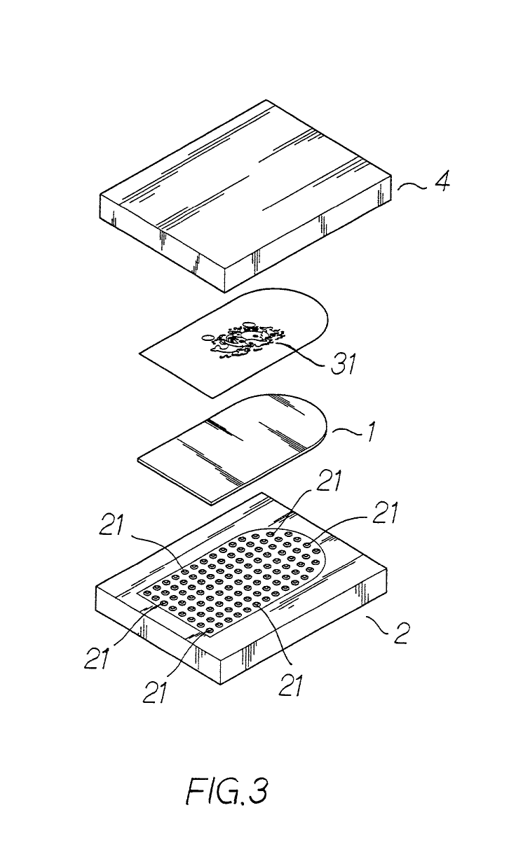

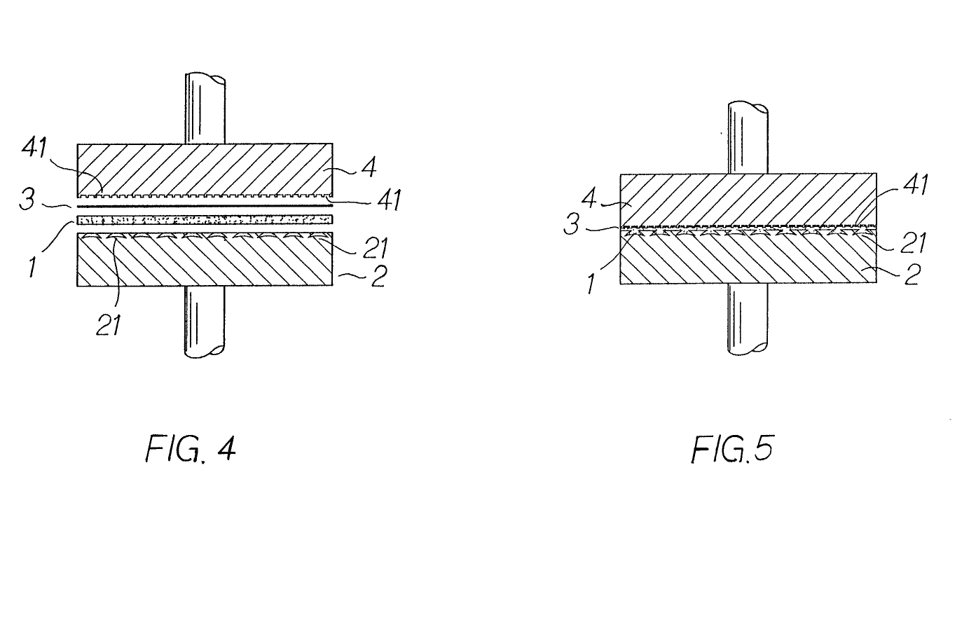

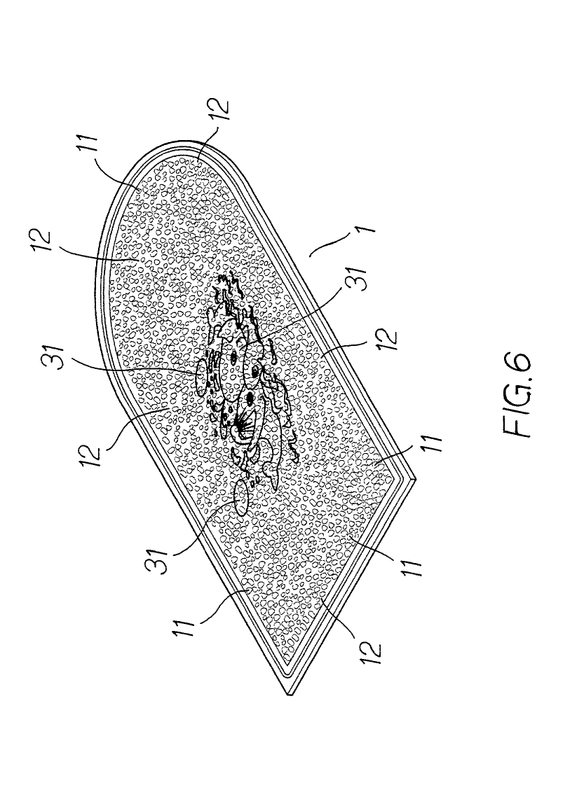

Referring to FIGS. 2 to 6, the manufacturing process of bathmat in accordance with the invention is detailed below. The body 1 of bathmat is cut from a piece of material formed of rubber or plastic material. The body 1 (i.e., unfinished product) is further washed, dried, and polished. Then put it on a lower mold 2 having a plurality of rounded recesses 21 thereon. Next place a layer of thin film 3 on the body 1 of bathmat. The layer of thin film 3 is formed of thermoplastic material with a mixture of temperature sensitive material. The layer of thin film 3 has a predetermined color pattern 31 formed thereon. Then place upper mold 4 on the layer of thin film 3 (FIG. 4). Upper mold 4 has a plurality of rounded recesses 41 on the bottom. Each rounded recess 41 has a depth no more than 0.3 mm. Next, press lower mold 2 and upper mold 4 on the body of bathmat 1 and layer of thin film 3 and apply heat at the same time (FIG. 5). Finally, tear off the layer of thin film 3. The finished bathmat 1 has a plurality of rounded slip resistant protrusions 11 on the top, a plurality of rounded suction plates on the bottom 13, a plurality of irregular grooves 12 each formed between slip resistant protrusions 11, and a printed pattern (i.e., a copy of the predetermined pattern 31). Note that the height of each slip resistant protrusion 11 is no more than 0.3 mm. Further, the printed pattern on bathmat 1 is durable because slip resistant protrusions 11 are rounded and have small height (i.e., no more than 0.3 mm), resulting in a total printing and uniform distribution of the predetermined pattern 31 on the top of bathmat 1. Furthermore, grooves 12 may function to dissipate heat during the manufacturing process.

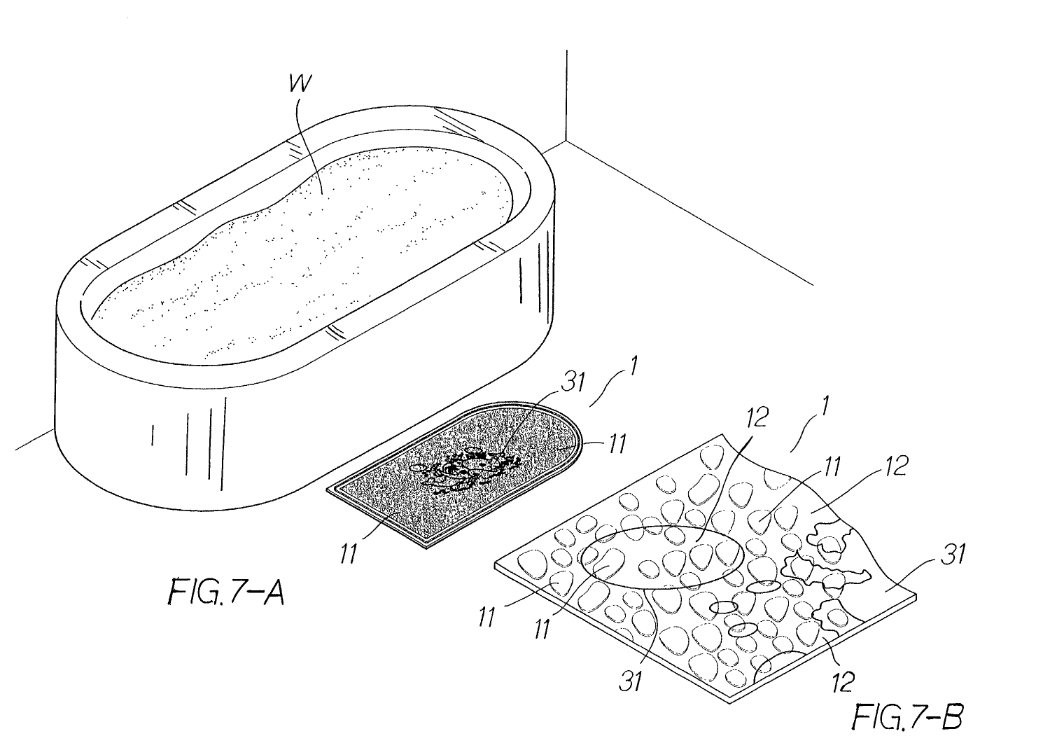

Referring to FIGS. 7A and 7B, the bathmat 1 is secured to the floor of bathroom near a bathtub full of hot water W by the plurality of suction plates 13 on the bottom.

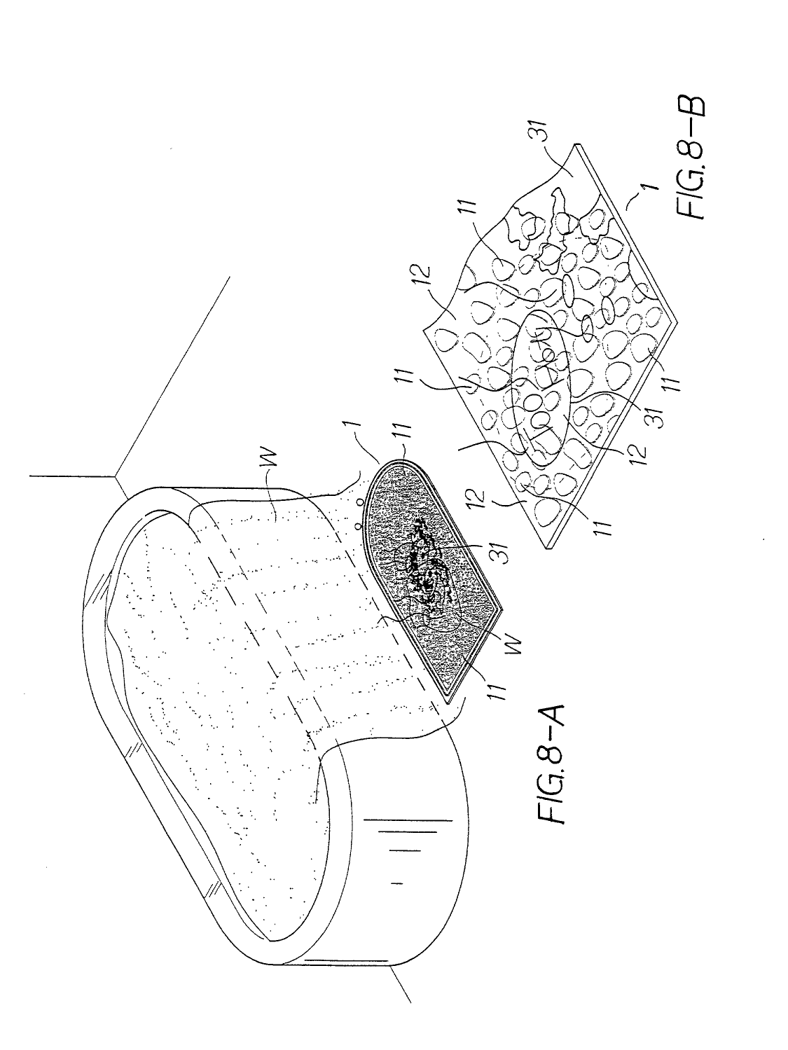

Referring to FIGS. 8A and 8B, it is possible for water W being spilt over bathmat 1 from bathtub carelessly. Then a warning (e.g., too hot as shown) is shown due to the addition of temperature sensitive material in the bathmat 1. In the embodiment, the warning is designed to show when the temperature of water W spilt on the pattern 31 of bathmat 1 is more than 38° C. This is a safe feature.

While the invention has been described by means of specific embodiments, numerous modifications and variations could be made thereto by those skilled in the art without departing from the scope and spirit of the invention set forth in the claims.

What is claimed is:

1. A bathmat manufacturing process comprising:
forming a bathmat body from a flexible material;
putting said bathmat body on a lower mold having a plurality of recesses thereon;
placing a layer of thin film on said bathmat body, said layer of thin film being formed of thermoplastic material with a mixture of temperature sensitive material, said layer of thin film having a predetermined pattern formed thereon;
placing an upper mold on said layer of thin film, said upper mold having a plurality of dents on said bottom;
pressing said lower mold and said upper mold on said bathmat body and said layer of thin film and applying heat; and
tearing off said layer of thin film to form a bathmat, including a plurality of slip resistant protrusions on said top, a plurality of projected suction plates on said bottom, a plurality of irregular grooves each formed between said slip resistant protrusions, and a printed pattern wherein a warning is shown when said temperature of an object in contact with said pattern of said bathmat is higher than a predetermined temperature.

2. The process of claim 1, wherein said height of each slip resistant protrusion is no more than 0.3 mm.

3. The process of claim 1, wherein each slip resistant protrusion is substantially rounded.

4. The process of claim 1, wherein said grooves are capable of dissipating heat during said manufacturing process.

5. The process of claim 1, wherein said predetermined temperature is 38° C.
